(19) United States
(12) Patent Application Publication
(10) Pub. No.: US 2009/0122395 A1
(43) Pub. Date: May 14, 2009

(54) LIGHT EMITTING DEVICE, LIGHT RECEIVING DEVICE, SPATIAL TRANSMISSION DEVICE, LENS DESIGN METHOD, AND ILLUMINATING DEVICE

(76) Inventor: Atsushi SHIMONAKA, Nara-shi (JP)

Correspondence Address: NIXON & VANDERHYE, PC, 901 NORTH GLEBE ROAD, 11TH FLOOR, ARLINGTON, VA, 22203, US

(21) Appl. No.: 12/211,118

(22) Filed: Sep. 16, 2008

(30) Foreign Application Priority Data
Nov. 9, 2007 (JP) P2007-291717

(51) Int. Cl. G02B 13/14

(52) U.S. Cl. 359/356

(57) ABSTRACT

This light emitting device has a light emitting part for emitting light into a range including an optical axis, and a radiation lens for refracting the light emitted from the light emitting part and radiating the light into outer space, the radiation lens provided around the optical axis so as to cover the light emitting part. In a coordinate system having an origin that is a center of the light emitting part, a y-axis that is the optical axis, and an x-axis orthogonal to the y-axis, an interface between the radiation lens and the outer space is expressed by a function y=g(x) in a domain of x≧0. Increase in |x| changes a sign of a second derivative d²g(x)/dx² of the function g(x) from negative to positive at an inflexion point x₀, and there is a recess on the interface of the lens.

### CROSS-REFERENCE TO RELATED APPLICATIONS

This Nonprovisional application claims priority under 35 U.S.C. §119(a) on Patent Application No. 2007-291717 filed in Japan on Nov. 9, 2007, the entire contents of which are hereby incorporated by reference.

### BACKGROUND OF THE INVENTION

The present invention relates to a light emitting device, a light receiving device, and an optical spatial transmission device composed of a combination of the light emitting device and the light receiving device.

The invention relates to a method of designing lenses suitable for the light emitting device and the light receiving device.

The invention relates to an illuminating device having the light emitting device.

FIG. 9 illustrates a manner on occasion when a user 900 listens to a sound reproduced by a portable moving-picture reproduction device 101 including an IrDA device. A term “IrDA device” refers to a device that performs communication in accordance with an infrared optical wireless communication standard determined by the Infrared Data Association, and designates a transmitter 102 and a receiver 104 in this example. Reproduction signals (1-bit digital signals) obtained by the portable moving-picture reproduction device 101 are modulated into infrared signals 103 by the transmitter 102 and are subsequently radiated into space. The receiver 104 receives the radiated infrared signals 103 and converts the signals into aural signals through a low-pass filter not shown. The user 900 listens to the sound through a head set 120 while watching moving pictures displayed on the portable moving-picture reproduction device 101.

FIG. 10 shows a sectional structure of a publicly known IrDA device 200. The IrDA device 200 has a light emitting diode chip 205, a light receiving chip 207, and an IC (integrated circuit) chip 209 for processing transmission/reception signals, the chips installed on a substrate 211. These chips 205, 207, and 209 are covered with resin 210 for protecting the semiconductor devices. On sites on a surface of the semiconductor device protecting resin 210, which correspond to the light emitting diode chip 205 and the light receiving chip 207, respectively, a radiation pattern control lens 206 and a light receiving condenser lens 208 are provided by integrated molding with use of the same material as the semiconductor device protecting resin 210. The radiation pattern control lens 206 and the light receiving condenser lens 208 are convex lenses shaped like semispheres or elliptical semispheres. Light 203′ from outer space is refracted on an interface of the lens 208, condensed, and made incident on a light receiving part of the light receiving chip 207 (a light receiving region formed on a surface of the chip).

FIG. 11 shows passage of a ray of light L emitted from a center O (which is set as an origin of xyz rectangular coordinates) of a light emitting part of such a light emitting element as the light emitting diode chip 205 (a light emitting region formed in the chip). The xyz rectangular coordinates are defined by a y-axis coinciding with an optical axis of (the light emitting part of) the light emitting diode chip 205, an x-axis perpendicular thereto, and a z-axis orthogonal to those axes. In a plane Q that includes the y-axis and that is inclined by an angle φ relative to the z-axis, the ray of light L emitted in a direction inclined by an angle θ relative to the y-axis is refracted on an interface S of the lens 206 into a direction inclined by an angle α relative to the y-axis. On condition that a light emitting surface of the light emitting diode chip 205 and the lens 206 are rotationally symmetrical with respect to the y-axis, the ray of light L advances in the plane Q without change in the azimuth angle φ of the ray of light L about the y-axis.

It has been known that a radiant intensity distribution in the lens 206 of light L emitted from the light emitting diode chip 205 is expressed by generalized Lambert distribution (hereinbelow, which will be referred to simply as “Lambert distribution”) of Expression (1) with a total light power designated by P₀.

$$f ( θ ) = {P}_{0} \frac{n + 1}{2 π} {cos}^{n} θ \qquad ( 1 )$$

(wherein n is an index referred to as “Lambert index”, which is herein equal to one) Therefore, a directional half intensity angle is 60 degrees For simplification, the total light power P₀ is assumed to be equal to 1 mW.

On condition that the lens 206 is shaped like a semisphere or an elliptical semispheres a radiant intensity distribution of the light L (corresponding to the signals 103 in FIG. 9 and the light 203 in FIG. 10) having passed through the interface S of the lens 206 is expressed by Expression (2).

$$F ( Θ ) = {P}_{0} \frac{N + 1}{2 π} {cos}^{N} Θ \qquad ( 2 )$$

Herein an index N is expressed as

N=ln(cos Θ_{H})/ln0.5 (3)

with use of a directional half intensity angle Θ_{H} (which means an angle that results in a radiant intensity being a half of maximum radiant intensity) posterior to the passage of the light through the interface S of the lens 206.

FIG. 12 shows a radiant intensity distribution, which is a Lambert distribution, with angles to the y-axis represented by a horizontal axis and with the radiant intensity represented by a vertical axis. The angle Θ to the y-axis that is equal to zero maximizes the radiant intensity. As the angle Θ to the y-axis increases, the radiant intensity decreases. The angle Θ being equal to the directional half intensity angle Θ_{H} halves the radiant intensity from the maximum, In this example, Θ_{H} is 27 degrees. Then the index N is equal to six in accordance with Expression (3).

As a manner of using an IrDA device, a manner where a user intentionally makes a transmitter and a receiver face each other and thereby effects data exchange in a short term used to be assumed chiefly, as is like a case of a transmitter and a receiver of a television system. Accordingly, there has been aimed satisfactory communication on a condition that the receiver resides within a given angle range and within a given distance range relative to the transmitter. In both JP H11-14935 A and JP 2005-189446 A, for example, a radiation range of light radiated from a transmitter is narrowly restricted and intensity distribution of the light is made uniform in the restricted radiation range.

Recently, however, a manner of use has been prevailing in which a user receives sounds in real time for a long period of time as in the case that the portable moving-picture reproduction device 101 described with reference to FIG. 9 is used. In such a manner of use lasting for a long period of time, it is difficult for a user to intentionally maintain the same posture while watching and listening. Thus the conventional portable moving-picture reproduction device 101 causes a problem in that the receiver may go out of an area in which communication can be carried out with the transmitter (an area in which the radiant intensity of 100 nW/cm² is obtained, in this example), e.g., when the user moves the transmitter in horizontal (left or right) directions in parallel while watching and listening.

### SUMMARY OF THE INVENTION

Therefore, an object of the invention is to provide a light emitting device, a light receiving device, and an optical spatial transmission device composed of a combination of the light emitting device and the light receiving device that are capable of properly ensuring a communicable area for optical wireless communication using a portable moving-picture reproduction device or the like.

Another object of the invention is to provide a lens design method suitable for such light emitting device and light receiving device.

Another object of the invention is to provide an illuminating device by which a wide illumination range can be attained.

It has been found from investigation carried out by the inventor et al. that a range of horizontal movement of a transmitter relative to a receiver is on the order of 20 cm which movement is caused by a change in posture of a user while the user watches and listens to a portable moving-picture reproduction device. That is, the transmitter relatively moves within a bullet-shaped range on the order of 1 m along a vertical direction y and 20 cm along a horizontal (left or right) direction x at hand with respect to the transmitter, as shown by a solid line in FIG. 13 (illuminance contour lines). Thus the bullet-shaped range LI_{R} of movement of the transmitter is required as the communicable area. In a conventional IrDA device such as the portable moving-picture reproduction device 101, the communicable area is a generally elliptic range LI_{P} shown by a broken line. In the conventional IrDA device, as seen from FIG. 13, a horizontal positional deviation allowable at hand of a user (a site at a vertical distance y on the order of 10 cm from the transmitter) is not larger than 20 cm. This fact causes the problem in that the receiver may go out of the area in which communication can be carried out with the transmitter, as described above.

On basis of such an investigation result as described above, the inventor has contrived devices that are capable of properly ensuring a communicable area for optical wireless communication using a portable moving-picture reproduction device or the like, as follows.

In order to accomplish the object, a light emitting device of an aspect of the present invention comprises:

a light emitting part for emitting light into a range including an optical axis, and

a radiation lens for refracting the light emitted from the light emitting part and radiating the light into outer space, the radiation lens provided around the optical axis so as to cover the light emitting part,

wherein, in a coordinate system having an origin that is a center of the light emitting part, a y-axis that is the optical axis, and an x-axis orthogonal to the y-axis, an interface between the radiation lens and the outer space is expressed by a function y=g(x) in a domain of x≧0, and wherein increase in |x| changes a sign of a second derivative d²g(x)/dx² of the function g(x) from negative to positive at an inflexion point x₀.

Herein the “optical axis” of the light emitting part refers to a straight line which extends from the light emitting part and in which emission intensity of light is maximized.

In the light emitting device of the invention, the light radiated into outer space acquires a radiant intensity distribution that provides a bullet-shaped illuminance contour line. Thus a communicable area for optical wireless communication using a portable moving-picture reproduction device or the like can properly be ensured.

In the light emitting device of one embodiment, an intensity distribution of the light radiated into the outer space substantially includes a factor

1/sin²Θ

(wherein Θ is an angle formed with the y-axis by the light).

In the light emitting device of this embodiment, the light radiated into outer space acquires the radiant intensity distribution that provides a generally desired illuminance contour line shaped like a bullet.

In the light emitting device of one embodiment, an intensity distribution of the light radiated into the outer space substantially includes a factor

1+cos²Θ+cos⁴Θ+cos⁶Θ+ . . . +cos^{2m}Θ

(wherein Θ is an angle formed with the y-axis by the light and m is an integer not less than 4).

In general, the following relational expression holds

1/sin²Θ=1+cos²Θ+cos⁴Θ+cos⁶Θ+ . . . +cos^{2m}Θ+ . . . .

In the light emitting device of this embodiment, a shape of interface of the radiation lens is approximated by the relational expression with M being an integer in a range of m≧4. Thus the light radiated into outer space acquires the radiant intensity distribution that provides a generally is desired illuminance contour line shaped like a bullet.

In the light emitting device of one embodiment, a size of the light emitting part is not larger than one-fifth that of the radiation lens in a direction of the x-axis.

In the light emitting device of this embodiment, the light radiated into outer space accurately acquires a radiant intensity distribution that provides an illuminance contour line shaped like a bullet.

In the light emitting device of one embodiment, the light emitting part comprises a surface-emitting laser.

In general, a light emitting surface of a surface-emitting laser has dimensions on the order of micrometers. In the light emitting device of this embodiment, therefore, a size of the radiation lens can be reduced in accordance with dimensions of the light emitting part on the order of micrometers.

A light receiving device of another aspect of the present invention comprises:

a light receiving part for receiving light from a range including an optical axis, and

a condenser lens for refracting light from outer space and making the light incident on the light receiving part, the radiation lens provided around the optical axis so as to cover the light receiving part,

wherein, in a coordinate system having an origin that is a center of the light receiving part, a y-axis that is the optical axis, and an x-axis orthogonal to the y-axis, an interface between the condenser lens and the outer space is expressed by a function y=h(x) in a domain of x≧0 and wherein increase in |x| changes a sign of a second derivative d²h(x)/dx² of the function h(x) from negative to positive at an inflexion point x₀.

Herein the “optical axis” of the light receiving part refers to a straight line which extends from the light receiving part and in which incident sensitivity of the light is maximized.

The light receiving device of the invention is capable of sensitively receiving light coming in horizontal directions from a short distance. Thus a communicable area for optical wireless communication using a portable moving-picture reproduction device or the like can properly be ensured.

In another aspect of the present invention, there is provided an optical spatial transmission device for performing optical wireless communication, the optical spatial transmission device comprising a combination of a light emitting device and a light receiving device,

the light emitting device comprising:

a light emitting part for emitting light into a range including an optical axis, and

a radiation lens for refracting the light emitted from the light emitting part and radiating the light into outer space, the radiation lens provided around the optical axis so as to cover the light emitting part,

wherein, in a coordinate system having an origin that is a center of the light emitting part, a y-axis that is the optical axis, and an x-axis orthogonal to the y-axis, an interface between the radiation lens and the outer space is expressed by a function y=g(x) in a domain of X≧0, and wherein increase in |x| changes a sign of a second derivative d²g(x)/dx² of the function g(x) from negative to positive at an inflexion point x₀,

the light receiving device comprising:

a light receiving part for receiving light from a range including an optical axis, and

a condenser lens for refracting light from the outer space and making the light incident on the light receiving part, the radiation lens provided around the optical axis so as to cover the light receiving part,

wherein, in a coordinate system having an origin that is a center of the light receiving part, a y-axis that is the optical axis, and an x-axis orthogonal to the y-axis, an interface between the condenser lens and the outer space is expressed by a function y=h(x) in a domain of x≧0, and wherein increase in |x| changes a sign of a second derivative d²h(x)/dx² of the function h(x) from negative to positive at an inflexion point x₀.

In the optical spatial transmission device of the invention, the light emitting device radiates light into outer space with a radiant intensity distribution that provides a bullet-shaped illuminance contour line. The light receiving device is capable of sensitively receiving light coming in horizontal directions from a short distance. In the optical spatial transmission device used as a portable moving-picture reproduction device, for example, a communicable area for optical wireless communication can properly be ensured.

In the optical spatial transmission device of the invention that is used for a visible light communication system, for example, space division and one-to-many communication can achieved.

In the optical spatial transmission device of one embodiment,

the light emitting device continuously transmits signals representing sounds, as the light, in real time, and wherein

the light receiving device continuously receives the signals representing the sounds, as the light, in real time.

In the optical spatial transmission device of this one embodiment, the light emitting device continuously transmits signals representing sound, as the light, in real time, and the light receiving device continuously receives the signals representing sound, as the light, in real time. Thus the optical spatial transmission device preferably constitutes a portable moving-picture reproduction device that reproduces images and sounds of moving pictures for a long period of time, for example.

In another aspect of the present invention, there is provided an illuminating device comprising the above light emitting device.

In the illuminating device of the invention, the light emitting device radiates light into outer space with a radiant intensity distribution that provides a bullet-shaped illuminance contour line. Therefore, the illuminating device of the invention is preferably used as a spotlight. The illuminating device of the invention is configured in small size.

In another aspect of the present invention, there is provided a lens interface design method for establishing the function g(x) that represents the interface between the radiation lens and the outer space for the above light emitting device, the lens interface design method comprising:

designating angles formed with the y-axis by light in the radiation lens emitted from the light emitting part and light radiated into the outer space as θ and Θ, respectively,

determining a directional half intensity angle θ_{H} that results in a radiant intensity being a half of a radiant intensity on the y-axis for the light in the radiation lens,

determining an index N by a relational expression n=ln(cos θH)/ln0.5, and

establishing the function g(x) by a numerical calculation method so that a relational expression between θ and Θ

$$1 - {cos}^{n + 1} θ = \frac{{\sum }_{m = 0}^{M} \frac{1}{2 m + 1} ( 1 - {cos}^{2 m + 1} Θ )}{{\sum }_{m = 0}^{M} \frac{1}{2 m + 1}}$$

(wherein M is an integer not less than 4) holds.

In a light emitting device designed in accordance with the lens interface design method of the invention, an intensity distribution of the light radiated into outer space substantially includes a factor:

1+cos²Θ+cos⁴Θ+cos⁶Θ+ . . . +cos^{2m}Θ

(wherein m≧4). Thus the radiant intensity distribution that provides a generally desired illuminance contour line shaped like a bullet is obtained with use of a single lens, for the light radiated into outer space. Therefore, a communicable area for optical wireless communication using a portable moving-picture reproduction device or the like can properly be ensured.

In another aspect of the present invention, there is provided a lens interface design method for establishing the function g(x) that represents the interface between the radiation lens and the outer space for the above light emitting device, the lens interface design method comprising:

designating angles formed with the y-axis by light in the radiation lens emitted from the light emitting part and light radiated into the outer space as θ and Θ, respectively,

determining a directional half intensity angle θ_{H} that results in a radiant intensity being a half of a radiant intensity on the y-axis for the light in the radiation lens,

determining an index N by a relational expression n=ln(cos θ_{H})/ln0.5, and

establishing the function g(x) by a numerical calculation method so that a relational expression between θ and Θ

$$1 - {cos}^{n + 1} θ = \frac{{\sum }_{m = 1}^{M} \frac{1}{2 m + 1} ( 1 - {cos}^{2 m + 1} Θ )}{{\sum }_{m = 1}^{M} \frac{1}{2 m + 1}}$$

(wherein M is an integer not less than 4) holds.

In a light emitting device designed in accordance with the lens interface design method of the invention, an intensity distribution of the light radiated into outer space substantially includes a factor:

1+cos²Θ+cos⁴Θ+cos⁶Θ+ . . . +cos^{2m}Θ

(wherein m≧4). Thus the radiant intensity distribution that provides a generally desired illuminance contour line shaped like a bullet is obtained with use of a single lens, for the light radiated into outer space. Therefore, a communicable area for optical wireless communication using a portable moving-picture reproduction device or the like can properly be ensured. Accordingly, a range of communication can be extended.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a diagram showing a sectional structure of an IrDA device in accordance with an embodiment of the invention;

FIG. 1B is a diagram showing a sectional structure of an IrDA device in accordance with another embodiment of the invention;

FIG. 2 is a diagram showing a radiant intensity distribution of light that is required for a portable moving-picture reproduction device and that is attained by the IrDA device of FIG. 1A;

FIG. 3 is a diagram showing a communicable area that is attained by the IrDA device of FIG. 1A and that exhibits a bullet-shaped illuminance contour line;

FIG. 4 is a diagram showing a shape of interface of a radiation pattern control lens in the IrDA device of FIG. 1A;

FIG. 5 is a diagram showing a communicable area that is different from that in FIG. 3 and that exhibits a bullet-shaped illuminance contour line;

FIG. 6 is a diagram illustrating a manner on occasion when a user listens to sound reproduced by a portable moving-picture reproduction device including the IrDA device of FIG. 1A;

FIG. 7 is a diagram showing a communicable area that is different from the areas in FIGS. 3 and 5;

FIG. 8 is a diagram showing an optical spatial transmission device 70 in accordance with an embodiment of the invention;

FIG. 9 is a diagram illustrating a manner on occasion when a user listens to sound reproduced by a portable moving-picture reproduction device including a conventional IrDA device;

FIG. 10 is a diagram showing a sectional structure of a conventional IrDA device;

FIG. 11 is a diagram showing passage of a ray of light emitted from a center of a light emitting part of a light emitting element;

FIG. 12 is a diagram showing a radiant intensity distribution of light that is attained by a conventional IrDA device; and

FIG. 13 is a diagram showing, for comparison, a communicable area of a conventional IrDA device and a communicable area that is required for a portable moving-picture reproduction device.

### DETAILED DESCRIPTION OF THE INVENTION

The present invention will be described hereinbelow in detail with conjunction to the embodiments with reference to the drawings.

### First Embodiment

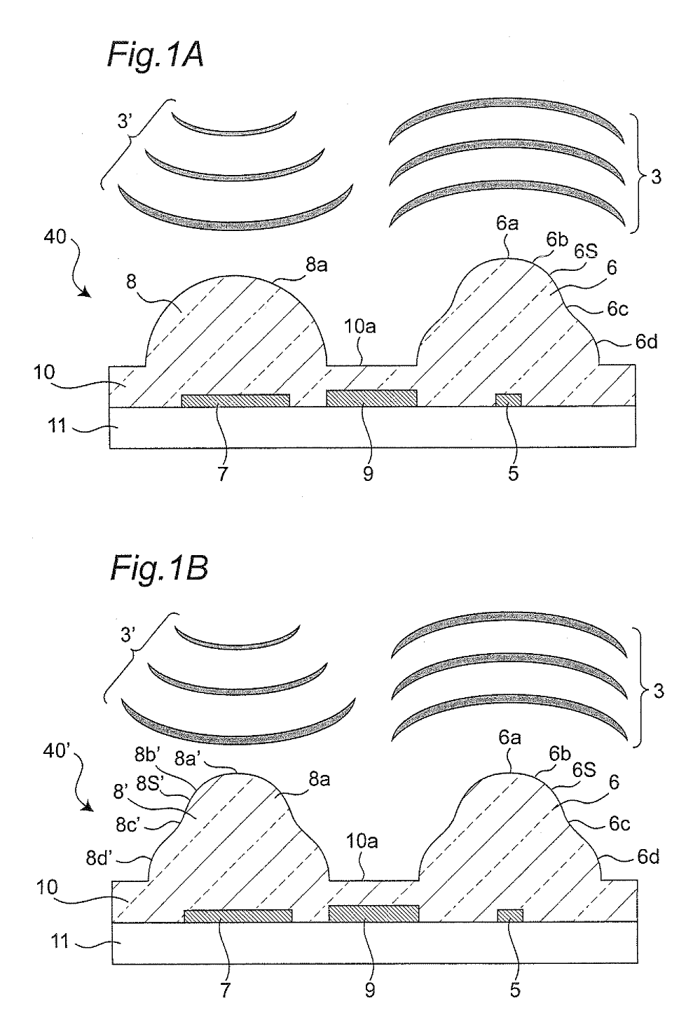

FIG. 1A shows a sectional structure of an IrDA device 40 as an embodiment of an optical spatial transmission device of the invention. The IrDA device 40 has a light emitting diode chip 5, a light receiving chip 7, and an IC (integrated circuit) chip 9 for processing transmission/reception signals, the chips installed on a substrate 11. In order to attain separation between transmission and reception, the light emitting diode chip 5 and the light receiving chip 7 are placed on opposite sides (left and right sides in FIG. 1A) of the IC chip 9 on the substrate 11. These chips 5, 7, and 9 are covered with resin 10 for protecting semiconductor device. On sites on a surface 10a of the semiconductor device protecting resin 10, which correspond to the light emitting diode chip 5 and the light receiving chip 7, respectively, a radiation pattern control lens 6 as a radiation lens and a light receiving condenser lens 8 as a condenser lens are provided by integrated molding with use of the same material as the semiconductor device protecting resin 10. In this example, the light emitting diode chip 5 and the radiation pattern control lens 6 form a transmitter as a light emitting device. The light receiving chip 7 and the light receiving condenser lens 8 form a receiver as a light receiving device.

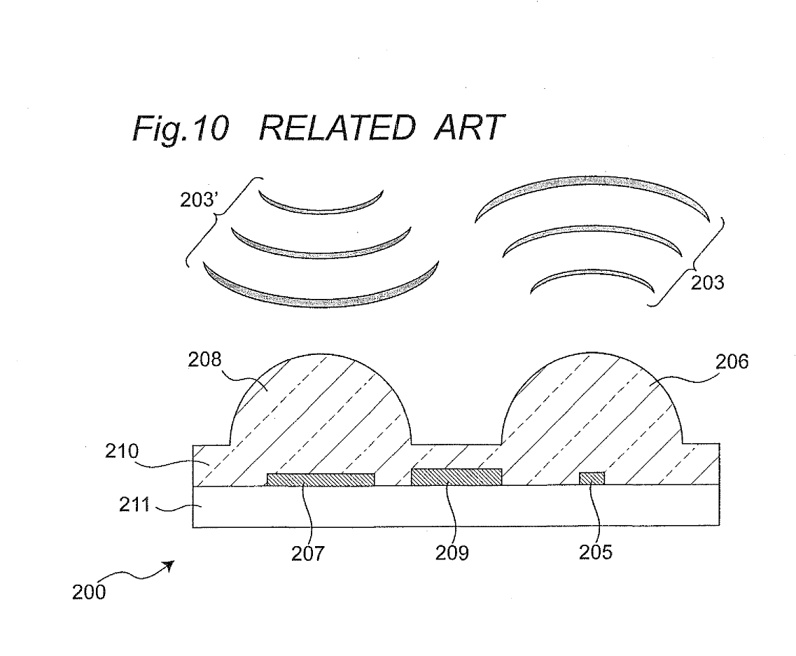

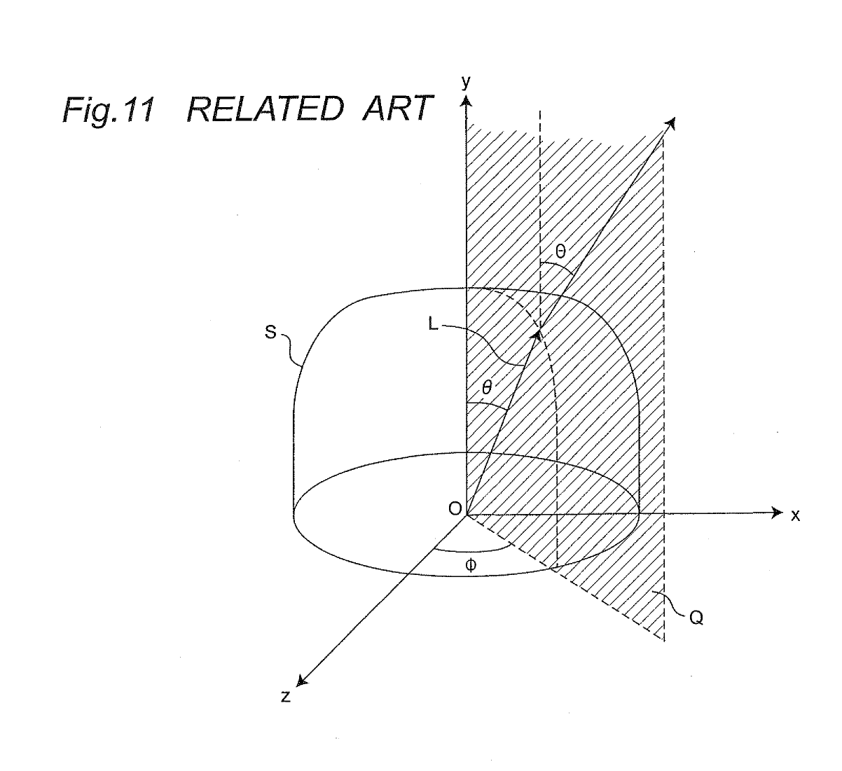

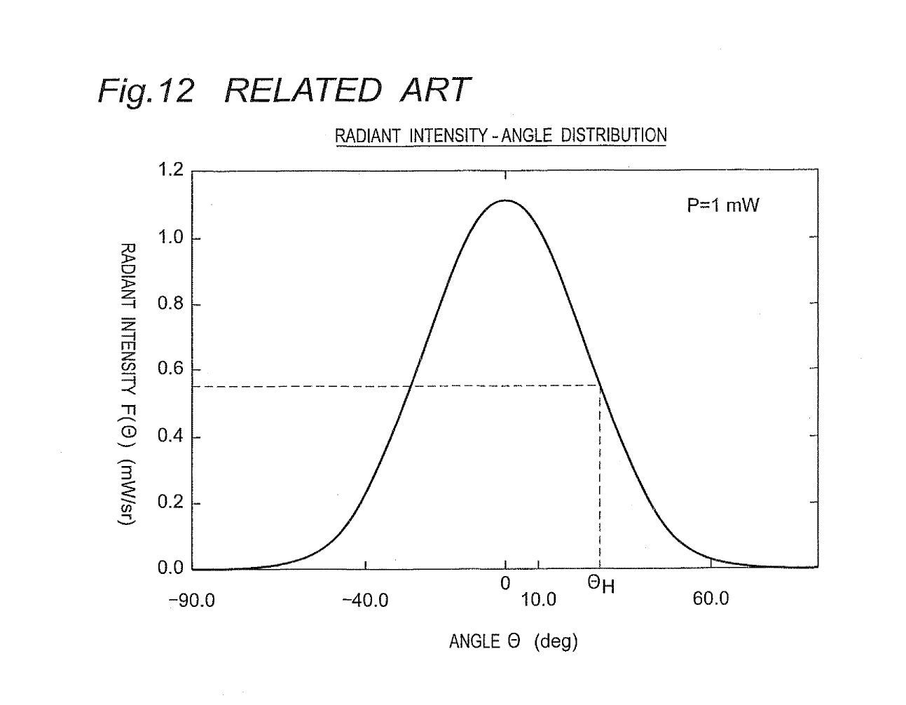

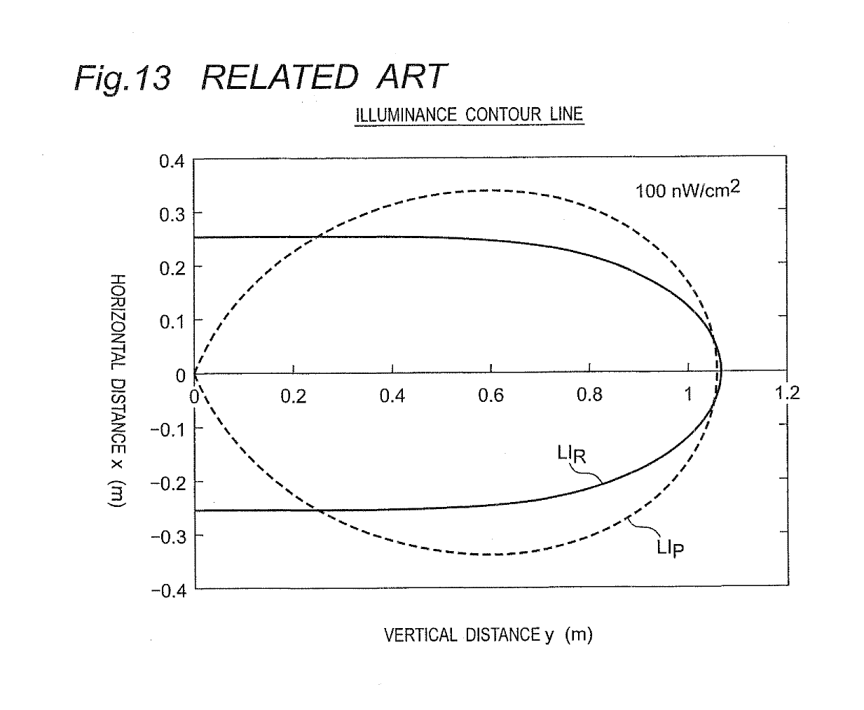

The light receiving condenser lens 8 is a convex lens shaped like a semisphere or an elliptical semisphere, as is the case with the conventional lens 208 (see FIG. 10). Light 3′ from outer space is refracted on an interface 8a of the lens 8, condensed, and made incident on a light receiving part of the light receiving chip 7 (a light receiving region formed on a surface of the chip). The radiation pattern control lens 6 is a convex lens having a shape of interface that will be described later, in contrast to the conventional lens 206 (see FIG. 10). Light 3 emitted from a light emitting part of the light emitting diode chip 5 (a light emitting region formed in the chip, which region is at a center of the chip in this example) is refracted on an interface 6S (which includes 6a, 6b, 6c, and 6d) of the lens 6, and is radiated in form of a desired radiation pattern into outer space.

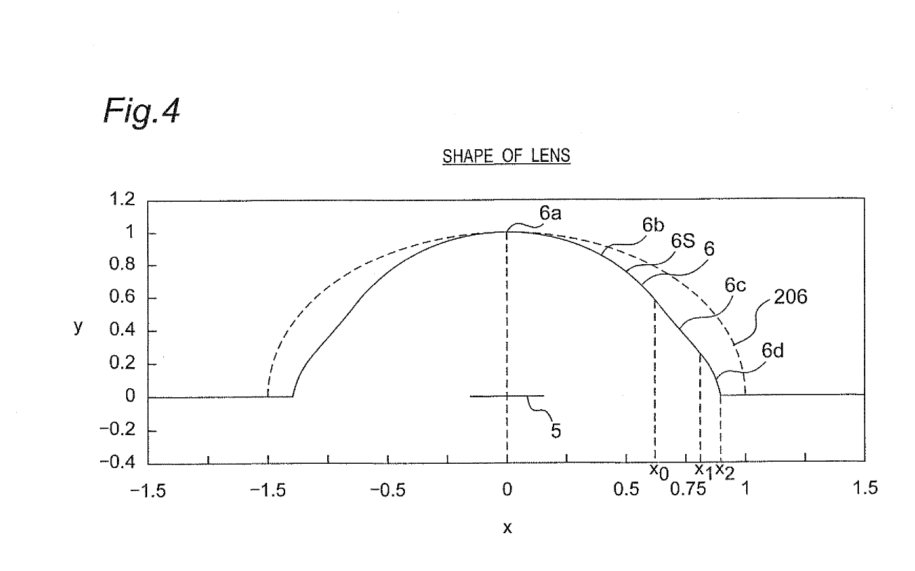

In FIG. 4, the shape of the interface 6S of the lens 6 is depicted by a solid line. For comparison, the interface of the conventional semispherical lens 206 is depicted by a broken line in FIG. 4. In FIG. 4 is defined a coordinate system having an origin O that is a center of the light emitting diode chip 5, a y-axis that is an optical axis of the light emitting diode chip 5 (shown by a broken line passing through the center of the chip 5 and a peak 6a of the lens 6, in this example), and an x-axis orthogonal to the y-axis. Herein, the interface 6S between the radiation lens 6 and outer space is rotationally symmetrical with respect to the y-axis, and is expressed by a function y=g(x) in a domain of x≧0. Hereinbelow will be described a manner in which the function y=g(x) is established by a lens interface design method of an embodiment.

Angles formed with the y-axis by the light in the lens 6 emitted from the light emitting diode chip 5 and the light radiated into outer space are designated by reference characters θ and Θ, respectively, as is the case with the angles described with reference to FIG. 10. A radiant intensity distribution in the lens 6 of the light emitted from the light emitting diode chip 5 is expressed by the Lambert distribution of Expression (1) described above with a total light power designated by P₀.

$$f ( θ ) = {P}_{0} \frac{n + 1}{2 π} {cos}^{n} θ \qquad ( 1 )$$

(wherein n is an index referred to as “Lambert index”, which is herein equal to one) For simplification, the total light power P₀ is assumed to be equal to 1 mW.

The index n is expressed by a relational expression n=ln(cos Θ_{H})/ln0.5, with use of a directional half intensity angle Θ_{H} (which means an angle that results in a radiant intensity being a half of a maximum radiant intensity) in a required radiant intensity distribution.

As for the light 3 radiated into outer space, a required radiant intensity distribution F(Θ) includes a factor:

1/sin²Θ (3)

In fact, the following general relational expression holds.

1/sin²Θ=1+cos²Θ+cos⁴Θ+cos⁶Θ+ . . . +cos^{2m}Θ+ . . . .

On condition that a right side is expanded to a term having m equal to 10, that is, to

cos²⁰Θ

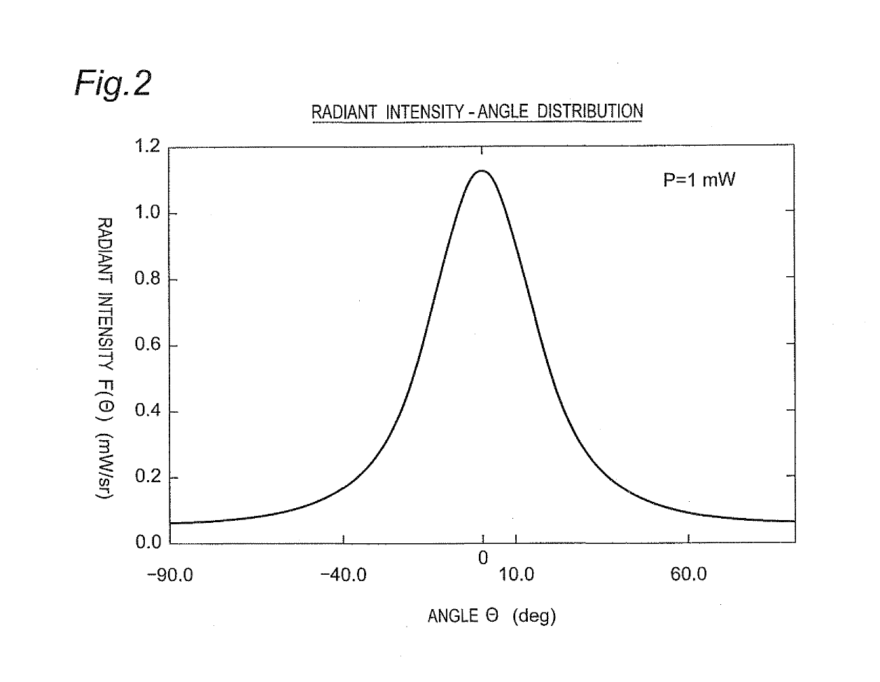

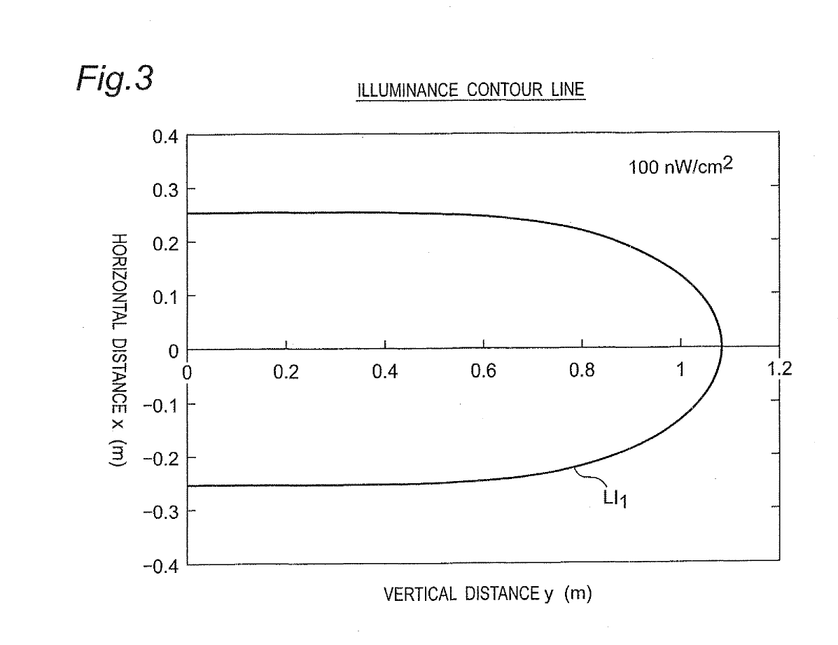

the required radiant intensity distribution F(Θ) of the light 3 radiated into outer space exhibits a distribution shown in FIG. 2. The distribution corresponds to a radiant intensity distribution LI₁ that exhibits a bullet-shaped illuminance contour line required for the light 3 radiated into outer space, as shown in FIG. 3.

Subsequently, the function g(x) is established by a numerical calculation method so that a relational expression between θ and Θ:

$$1 - {cos}^{n + 1} θ = \frac{{\sum }_{m = 0}^{M} \frac{1}{2 m + 1} ( 1 - {cos}^{2 m + 1} Θ )}{{\sum }_{m = 0}^{M} \frac{1}{2 m + 1}} \qquad ( 4 )$$

(wherein n is equal to one and M is an integer not less than 4) holds.

Expression (4) is obtained by standardization of Expressions (1) and (3) such that those Expressions have the same optical power, and by equation of integrals of those Expressions to θ and Θ on the semisphere. Herein used is the following formula.

$$\frac{1}{{sin}^{2} θ} = 1 + {cos}^{2} θ + {cos}^{4} θ + {cos}^{6} θ + … = {\sum }_{m = 0}^{∞} {cos}^{2 m} θ$$

This formula is expanded to m=M=10. In FIG. 4 described above, Expression (4) is depicted with a refraction index of the lens set at 1.6 and with a height of the lens 6 standardized to 1.

Sign of a second derivative d²g(x)/dx² of the function g(x) is determined by Expression (5).

$$\frac{{d}^{2} g}{d {x}^{2}} = \{ \begin{matrix}0 & ( x = 0 ) \\ < 0 & ( 0 < x < {x}_{0} ) \\ 0 & ( x = {x}_{0} ) \\ > 0 & ( {x}_{0} < x < {x}_{1} ) \\ 0 & ( x = {x}_{1} ) \\ < 0 & ( {x}_{1} < x \leq {x}_{2} )\end{matrix} \qquad ( 5 )$$

That is, d²g(x)/dx²=0 holds at the peak 6a of the lens 6, i.e., with x=0. As x increases from 0, the sign of d²g(x)/dx² becomes and remains minus for a while and the interface 6b of the lens 6 has a shape protruding upward. As x further increases, d²g×)/dx² becomes zero at an inflexion point x₀. As x increases from x₀, the sign of d²g(x)/dx² becomes and remains plus for a while and the interface 6c of the lens 6 has a shape protruding downward. As x further increases, d²g(x)/dx² becomes zero at another inflexion point x₁. As x increases from x₁, the sign of d²g(x)/dx² becomes minus and the interface 6d of the lens 6 has a shape protruding upward. Subsequently x reaches an end x₂ of the lens 6.

In comparison with the semispherical lens 206, the lens interface 6S expressed by the function g(x) is characterized in that the lens interface 6c exhibits a recess in vicinity of x=0.75. This characteristic is common on condition of M≧4. The shape of the recess hardly changes on condition that common material such as resin, glass or the like is used as material of the lens 6 and has a refractive index in a range between 1.2 and 1.8. Even if the radiant intensity distribution in the lens 6 is slightly deviated from the Lambert distribution of n=1, the lens interface can be converted directly into numerical form as the function g(x) with use of Expression (4).

As long as the radiation pattern control lens 6 shown in FIG. 1A has the lens interface 6S expressed by the function g(x), the radiant intensity distribution LI₁ having the illuminance contour line that exhibits the bullet-like shape can be obtained for the light 3 radiated into outer space, as shown in FIG. 3. Thus there can properly be ensured an area in which communication can be carried out (an area in which the radiant intensity of 100 nW/cm² is obtained, in this example) for optical wireless communication using a portable moving-picture reproduction device or the like. Accordingly, a range of communication can be extended.

Hereinbelow, description will be given on the index M (and the index m). In vicinity of θ=0, cos^{2m}θ becomes one. Hence the expansion

$$\frac{1}{{sin}^{2} θ} = 1 + {cos}^{2} θ + {cos}^{4} θ + {cos}^{6} θ + … = {\sum }_{m = 0}^{∞} {cos}^{2 m} θ$$

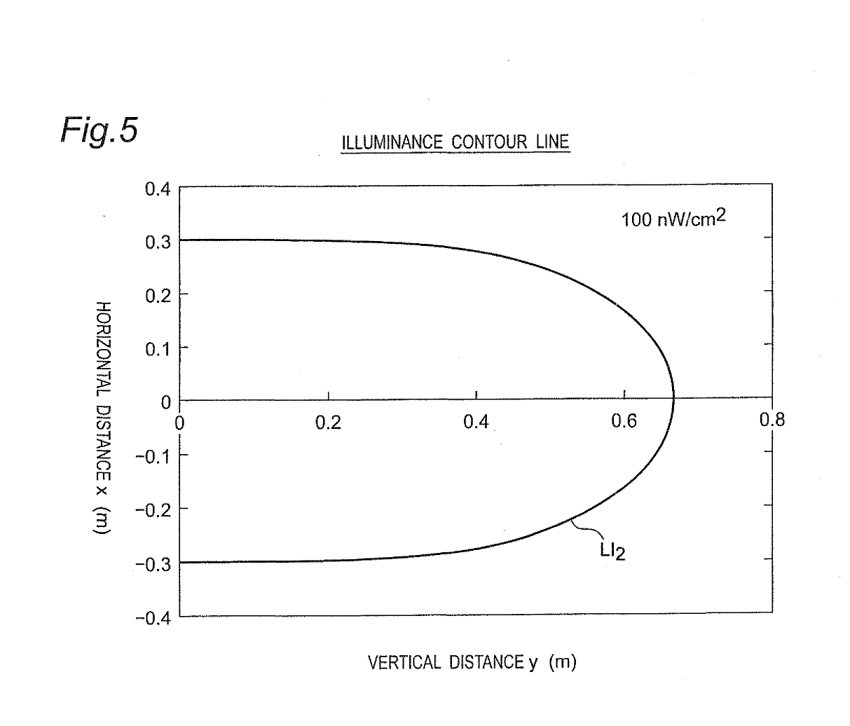

does not converge with increase in m. With increase in the index M, the communicable area extends in form of the bullet. It is therefore preferable to select an optimal index M on the order of M≧4 and to find the function g(x) by the numerical calculation method. Though the increase in the index M causes increased bother in the numerical calculation, it does not complicate a configuration of the transmitter because the single lens (the single surface lens) is obtained. Thus the shape of the communicable area can easily be changed only by the change in the index M. For example, FIG. 5 shows a communicable area LI₂ obtained from the index M=4. In comparison with FIG. 3 with M=10, the index M=4 widens the communicable area in horizontal directions and makes the vertical communicable range the smaller from about 10⁶ cm to about 67 cm. In both the configurations, there are no change in the total light power for transmission and no loss of light that might be caused by the lens 6.

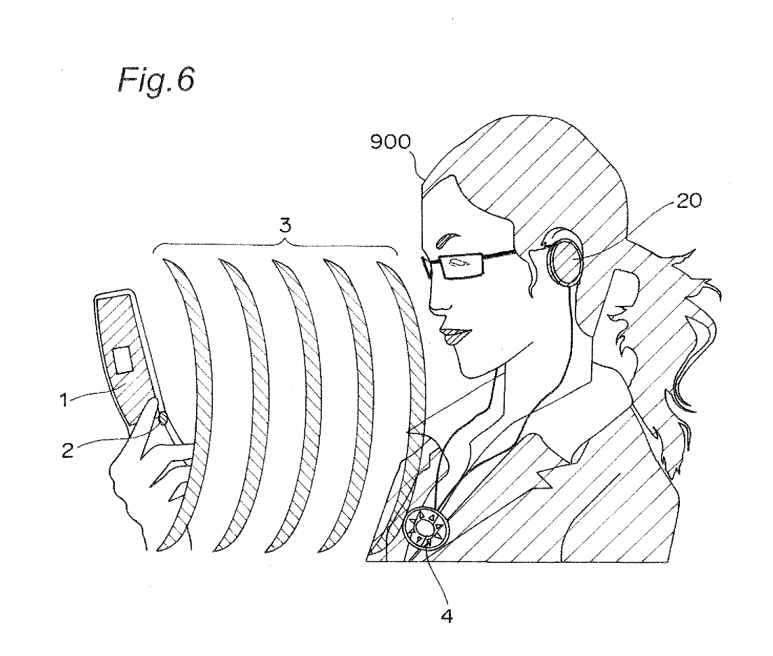

FIG. 6 illustrates a manner on occasion when a user 900 listens to sound reproduced by a portable moving-picture reproduction device 1 including the IrDA device of FIG. 1A. Reproduction signals (1-bit digital signals) obtained by the portable moving-picture reproduction device 1 are modulated into infrared signals 3 by the transmitter 2 and are continuously radiated in real time. The receiver 4 continuously receives the radiated infrared signals 3 in real time and converts the signals into aural signals through a low-pass filter not shown. The user 900 listens to the sounds through a head set 20 while watching moving pictures displayed on the portable moving-picture reproduction device 1. Thus the user 900 is allowed to watch and Listen to images and sounds of the moving pictures for a long period of time.

As seen from FIGS. 3, 5, and the like, a horizontal positional deviation allowable at hand of a user (position at a vertical distance y not larger than 10 cm from the transmitter) is not smaller than 20 cm. This is prevents the problem in which the receiver may go out of the area in which communication can be carried out with the transmitter as in conventional devices. The user 900 is thus allowed to stably receive sounds without necessity of paying attention to holding his/her posture when watching and listening.

### Second Embodiment

In the IrDA device 40 of the first embodiment, even sites at the vertical distance y smaller than 10 cm, e.g., y=0 from the transmitter allow a horizontal positional deviation not smaller than 20 cm and are thus included in the communicable area. This means that the communicable range in the vertical directions y is made smaller by a length comparable to the extension in the communicable area in the horizontal directions x, assuming that the total light power of the transmitter is constant, as seen from discussion on the index M in the first embodiment. Assuming that the communicable range in the vertical directions y is constant, this also means that the total light power of the transmitter has to be larger by an amount comparable to the extension in the communicable area in the horizontal directions x.

On the other hand, it is impossible for a user to watch moving pictures and listen in positions at the vertical distances y smaller than 10 cm from the transmitter because a focal length of a human eyeball is commonly not smaller than 10 cm.

In a second embodiment, therefore, reduction in power consumption of the transmitter is aimed for with optimization of the communicable range in the horizontal directions x at the sites at the vertical distances y smaller than 10 cm relative to the transmitter. In the second embodiment, a configuration of an IrDA device in real space is almost the same as that of the first embodiment, and description thereof will be given with a drawing thereof omitted.

In the second embodiment, specifically, Expression (6) is substituted for Expression (4) in the first embodiment. That is, the function g(x) is established by a numerical calculation method so that a relational expression between θ and Θ:

$$1 - {cos}^{n + 1} θ = \frac{{\sum }_{m = 1}^{M} \frac{1}{2 m + 1} ( 1 - {cos}^{2 m + 1} Θ )}{{\sum }_{m = 1}^{M} \frac{1}{2 m + 1}} \qquad ( 6 )$$

(wherein M is an integer not less than 4) holds.

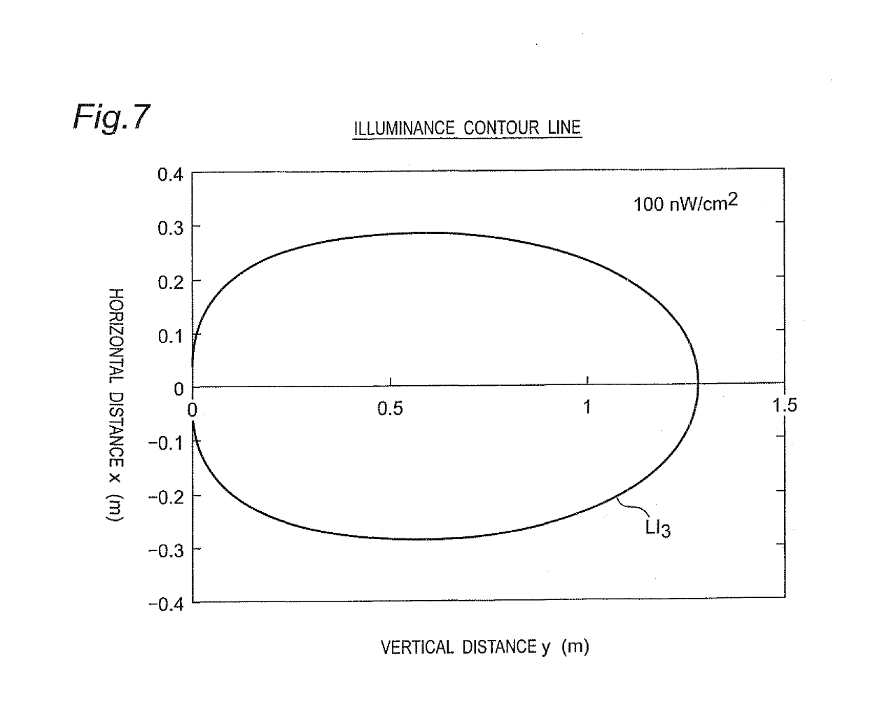

FIG. 7 shows a communicable area LI₃ of the IrDA device of the second embodiment with the index M=10 and a refractive index of a lens of 1.6. In the example of FIG. 7, as apparent, the communicable area is optimized by being narrowed in the horizontal directions x at the sites at the vertical distances y smaller than 10 cm relative to the transmitter, e.g., in comparison with the example of FIG. 3. Thus the communicable range in the vertical directions y is made larger by a length comparable to the decrease in width of the communicable area in the horizontal directions x at the sites at the vertical distances y smaller than 10 cm relative to the transmitter, provided that the total light power of the transmitter is constant (in power consumption). For example, the communicable range in the vertical directions y is elongated from about 106 cm in the example of FIG. 3 to about 1.28 m in the example of FIG. 7. Assuming that the communicable range in the vertical directions y is constant, the power consumption of the transmitter can be made smaller by an amount comparable to the decrease in width of the communicable area in the horizontal directions x at the sites at the vertical distances y smaller than 10 cm relative to the transmitter. For example, a power consumption ratio of the example of FIG. 7 to the example of FIG. 3 is (1.06/1.28)². That is, the power consumption can be reduced by about 30%.

### Third Embodiment

Though the invention is applied to the shape of the interface 6S of the radiation pattern control lens 6 in the IrDA devices of the first and second embodiments, the invention is not limited thereto. If the shape of the interface of the lens of the invention is applied to the light receiving condenser lens 8 shown in FIG. 1A, for example, effects similar to those described with regard to the first and second embodiments can be expected. In FIG. 1B, there is shown a sectional structure of such an IrDA device 40′. In the IrDA device 40′, the light receiving chip 7 is covered by the light receiving condenser lens 8′ equivalent to the radiation pattern control lens 6 by which the light emitting diode chip 5 is covered. Shape of the interface 8S′ (which includes 8a′, 8b′, 8c′ and 8d′) of the light receiving condenser lens 8′ is in correspondence with the shape of the interface 6S of the lens 6. That is, partial interfaces 8a′, 8b′, 8c′ and 8d′ of the lens 8′ are in correspondence with partial interfaces 6a, 6b, 6c, and 6d of the lens 6, respectively.

Provided that the interface 8S′ between the condenser lens 8′ and outer space is expressed by a function y=h(x) in a domain of x≧0, sign of a second derivative d²h(x)/dx² of the function h(x) is determined by Expression (7) as follows.

$$\frac{{d}^{2} h}{d {x}^{2}} = \{ \begin{matrix}0 & ( x = 0 ) \\ < 0 & ( 0 < x < {x}_{0} ) \\ 0 & ( x = {x}_{0} ) \\ > 0 & ( {x}_{0} < x < {x}_{1} ) \\ 0 & ( x = {x}_{1} ) \\ < 0 & ( {x}_{1} < x \leq {x}_{2} )\end{matrix} \qquad ( 7 )$$

In such an example, a receiver that communicates with a transmitter in one-to-one correspondence is capable of sensitively receiving light coming in a horizontal direction from a short distance. Thus a communicable area for optical wireless communication using a portable moving-picture reproduction device or the like can properly be ensured.

In a system in which only deviation with a given angle to the transmitter is assumed, it is sufficient to use a receiver having a conventional lens. In a system or a scene of use in which the angle deviation scarcely occurs but horizontal positional deviation may occur, it may be convenient for a sensitivity-angle curve for the receiver to include the factor

1/sin²Θ

of Equation (3) For example, LAN (local area network) among fixed stations and the like apply to this example. In transmitters and receivers that are mounted on walls on rooftop of buildings and the like, the angle cannot be changed but great resistance is required against positional shift that might be caused by meteorological conditions such as fluctuation in refractive index of air and wind. In such a case, sensitivity of the reception can be improved by application of the shape of the interface of the lens of the invention to the light receiving condenser is lens of the receiver.

### Fourth Embodiment

Though the light emitting diode chip 5 forms the light emitting part in the IrDA device 40 of the first embodiment, the invention is not limited thereto. In a fourth embodiment, for example, a semiconductor laser chip of surface-emitting type (which will be described with use of the same numeral 5 as the light emitting diode chip in FIG. 1A) forms the light emitting part. In the semiconductor laser chip 5 of surface-emitting type, with reference to FIG. 1A, a light emitting surface (light emitting part) for laser oscillation has dimensions on the order of micrometers, e.g., a diameter of 10 μm in this example. With use of the semiconductor laser chip 5 of surface-emitting type having such a small light emitting surface, a radiation pattern thereof acquires values extremely close to a Lambert distribution. Our examination has proven that the effects described with regard to the first and second embodiments can sufficiently be obtained on condition that a diameter of the light emitting surface is not larger than one-fifth that of the lens 6, in other words, on condition that the diameter of the lens 6 is not less than five times that of the light emitting surface.

In a common light emitting diode chip, which has a light emitting surface with a size on the order of 0.3 mm in diameter, a radiant intensity distribution thereof can successfully be controlled on condition that the lens 6 has a diameter of 1.5 mm.

### Fifth Embodiment

Hereinbelow will be described an illuminating device as a fifth embodiment of the invention. With reference to FIG. 1A, the illuminating device of the fifth embodiment is composed of the light emitting device, i.e., the light emitting diode chip 5 and the radiation pattern control lens 6, in the IrDA device 40 of the first embodiment. In this example, the light emitting diode chip 5 emits bluish-violet light. The light emitting diode chip 5 is enclosed in immediate surroundings thereof by fluorescent material (not shown) in place of the material that constitutes the lens 6. The fluorescent material absorbs the bluish-violet light and emits white light by fluorescent effect. It is known that the emitted white light has Lambert distribution. The lens interface 6 having the shape obtained from the invention is formed on an optical axis extending from the light emitting diode chip 5 to outer space. Thus the light emitting device radiates light into outer space with a radiant intensity distribution that provides a bullet-shaped illuminance contour line. Therefore, the illuminating device is preferably used as a spotlight. The illuminating device is also configured in small size.

### Sixth Embodiment

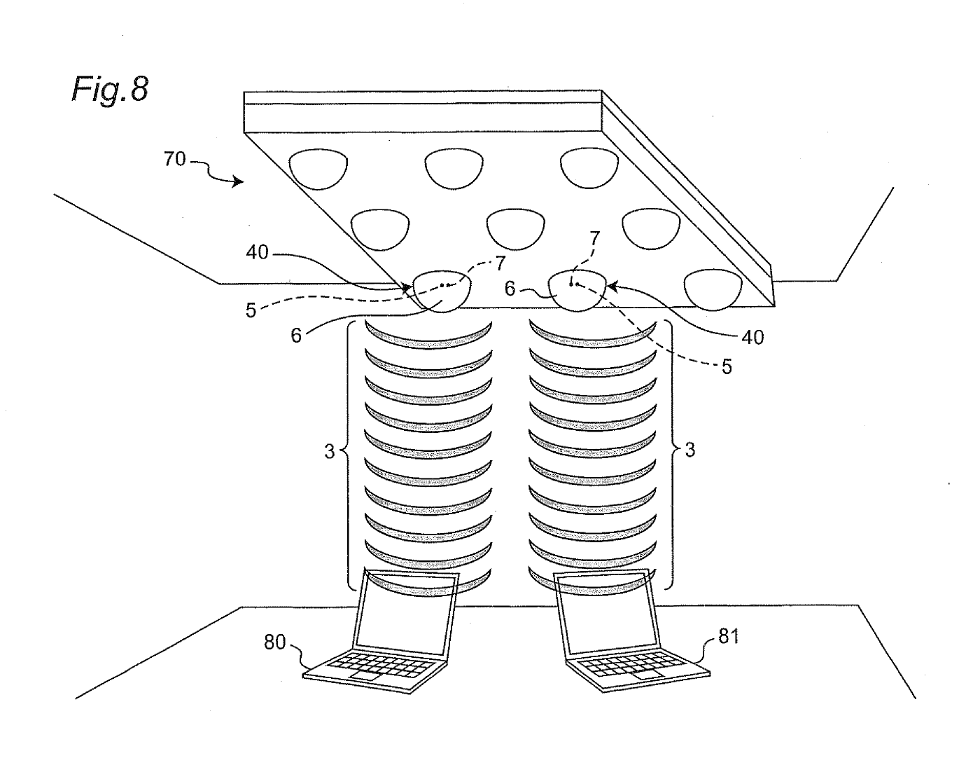

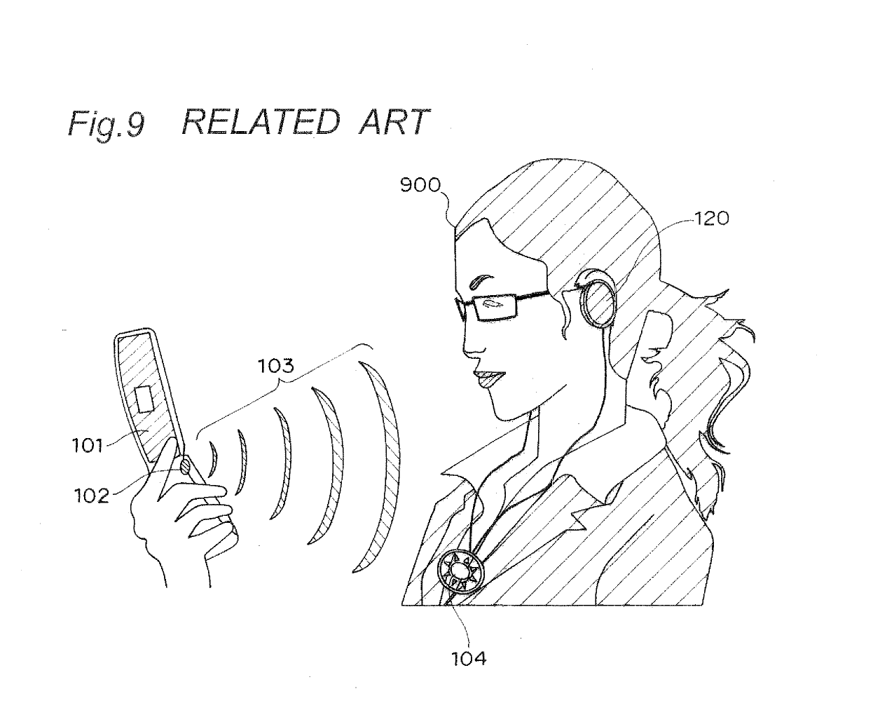

FIG. 8 shows an optical spatial transmission device 70 as a sixth embodiment of the invention. The optical spatial transmission device 70 is configured by provision of a plurality of IrDA devices 40, 40 of the first embodiment on a ceiling in a room. Each IrDA device 40 is composed of a light emitting diode chip 5 and a light receiving chip 7 that are covered with a radiation pattern control lens 6.

In this example, each IrDA device 40 radiates visible light 3 emitted from the light emitting diode chip 5, with the radiant intensity distribution LI₃ shown in FIG. 7 and with downward directivity. On a desk in the room are placed notebook personal computers 80, 81 each containing an IrDA device (not shown) similar to the IrDA device 40 of the first embodiment. Each of the personal computers 80, 81 independently performs optical communication using visible light with the IrDA device 40 to which the personal computer corresponds.

In such a configuration, a communicable area is separately established for each IrDA device 40 because the IrDA devices 40 have satisfactory directivity. This makes it possible for each personal computer 80, 81 to carry out data communication independently in parallel.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A light emitting device comprising:
a light emitting part for emitting light into a range including an optical axis, and
a radiation lens for refracting the light emitted from the light emitting part and radiating the light into outer space, the radiation lens provided around the optical axis so as to cover the light emitting part,
wherein, in a coordinate system having an origin that is a center of the light emitting part, a y-axis that is the optical axis, and an x-axis orthogonal to the y-axis, an interface between the radiation lens and the outer space is expressed by a function y=g(x) in a domain of x≧0, and wherein increase in |x| changes a sign of a second derivative d²g(x)/dx² of the function g(x) from negative to positive at an inflexion point x₀.

2. The light emitting device as claimed in claim 1, wherein
an intensity distribution of the light radiated into the outer space substantially includes a factor
1/sin²Θ
(wherein Θ is an angle formed with the y-axis by the light).

3. The light emitting device as claimed in claim 1, wherein
an intensity distribution of the light radiated into the outer space substantially includes a factor
1+cos²Θ+cos⁴Θ+cos⁶Θ+ . . . +cos^{2m}Θ
(wherein Θ is an angle formed with the y-axis by the light and m is an integer not less than 4).

4. The light emitting device as claimed in claim 1, wherein
a size of the light emitting part is not larger than one-fifth that of the radiation lens in a direction of the x-axis.

5. The light emitting device as claimed in claim 4, wherein
the light emitting part comprises a surface-emitting laser.

6. A light receiving device comprising:
a light receiving part for receiving light from a range including an optical axis, and
a condenser lens for refracting light from outer space and making the light incident on the light receiving part, the radiation lens provided around the optical axis so as to cover the light receiving part,
wherein, in a coordinate system having an origin that is a center of the light receiving part, a y-axis that is the optical axis, and an x-axis orthogonal to the y-axis, an interface between the condenser lens and the outer space is expressed by a function y=h(x) in a domain of x≧0, and wherein increase in |x| changes a sign of a second derivative d²h(x)/dx² of the function h(x) from negative to positive at an inflexion point x₀.

7. An optical spatial transmission device for performing optical wireless communication,
the optical spatial transmission device comprising a combination of a light emitting device and a light receiving device,
the light emitting device comprising:
a light emitting part for emitting light into a range including an optical axis, and
a radiation lens for refracting the light emitted from the light emitting part and radiating the light into outer space, the radiation lens provided around the optical axis so as to cover the light emitting part,
wherein, in a coordinate system having an origin that is a center of the light emitting part, a y-axis that is the optical axis, and an x-axis orthogonal to the y-axis, an interface between the radiation lens and the outer space is expressed by a function y=g(x) in a domain of X≧0, and wherein increase in |x| changes a sign of a second derivative d²g (x)/dx² of the function g(x) from negative to positive at an inflexion point x₀,
the light receiving device comprising:
a light receiving part for receiving light from a range including an optical axis, and
a condenser lens for refracting light from the outer space and making the light incident on the light receiving part, the radiation lens provided around the optical axis so as to cover the light receiving part,
wherein, in a coordinate system having an origin that is a center of the light receiving part, a y-axis that is the optical axis, and an x-axis orthogonal to the v-axis, an interface between the condenser lens and the outer space is expressed by a function y=h(x) in a domain of x≧0, and wherein increase in |x| changes a sign of a second derivative d²h(x)/dx² of the function h(x) from negative to positive at an inflexion point x₀.

18. The optical spatial transmission device as claimed in claim 7, wherein
the light emitting device continuously transmits signals representing sounds, as the light, in real time, and wherein
the light receiving device continuously receives the signals representing the sounds, as the light, in real time.

9. An illuminating device comprising the light emitting device as claimed in claim 1.

10. A lens interface design method for establishing the function g(x) that represents the interface between the radiation lens and the outer space for the light emitting device as claimed in claim 1, the lens interface design method comprising:
designating angles formed with the y-axis by light in the radiation lens emitted from the light emitting part and light radiated into the outer space as θ and Θ, respectively,
determining a directional half intensity angle θ_{H} that results in a radiant intensity being a half of a radiant intensity on the y-axis for the light in the radiation lens,
determining an index N by a relational expression n=ln(cos θ_{H})/ln0.5, and
establishing the function g(x) by a numerical calculation method so that a relational expression between θ and Θ
$$1 - {cos}^{n + 1} θ = \frac{{\sum }_{m = 0}^{M} \frac{1}{2 m + 1} ( 1 - {cos}^{2 m + 1} Θ )}{{\sum }_{m = 0}^{M} \frac{1}{2 m + 1}}$$
(wherein M is an integer not less than 4) holds.

11. A lens interface design method for establishing the function g(x) that represents the interface between the radiation lens and the outer space for the light emitting device as claimed in claim 1, the lens interface design method comprising:
designating angles formed with the y-axis by light in the radiation lens emitted from the light emitting part and light radiated into the outer space as θ and Θ, respectively,
determining a directional half intensity angle θ_{H} that results in a radiant intensity being a half of a radiant intensity on the y-axis for the light in the radiation lens,
determining an index N by a relational expression n=ln(cos θ_{H})/ln0.5, and
establishing the function g(x) by a numerical calculation method so that a relational expression between θ and Θ
$$1 - {cos}^{n + 1} θ = \frac{{\sum }_{m = 1}^{M} \frac{1}{2 m + 1} ( 1 - {cos}^{2 m + 1} Θ )}{{\sum }_{m = 1}^{M} \frac{1}{2 m + 1}}$$
(wherein M is an integer not less than 4) holds.
